(19) United States
(12) Patent Application Publication
(10) Pub. No.: US 2012/0124616 A1
(43) Pub. Date: May 17, 2012

(54) MOBILE INTERNET PROTOCOL TELEVISION SYSTEM AND METHOD THEREOF

(75) Inventors: Young Sic JEONG, Daejeon (KR); Mi Young Huh, Daejeon (KR); Shin Gak Kang, Daejeon (KR)

(73) Assignee: ELECTRONICS AND TELECOMMUNICATIONS RESEARCH INSTITUTE, Daejeon (KR)

(21) Appl. No.: 13/245,960

(22) Filed: Sep. 27, 2011

(30) Foreign Application Priority Data
Nov. 15, 2010 (KR) 10-2010-0113550

(51) Int. Cl. H04N 5/445; H04N 7/167; H04N 7/16

(52) U.S. Cl. 725/31; 725/39

(57) ABSTRACT

Disclosed is a mobile Internet protocol television (IPTV) system providing a supplementary service added to a broadcasting service. The mobile IPTV system includes a service guide server providing programming information of an additional service, a media server providing streaming of contents for a supplementary service, a supplementary service server providing control for the supplementary service, and a mobile IPTV management server performing user authentication for the supplementary service. In this case, the mobile IPTV management server, the media server, the service guide server and the supplementary service server are connected to each other via a dedicated wireless IP network.

### CROSS-REFERENCE TO RELATED APPLICATION

This application claims priority to and the benefit of Korean Patent Application No. 10-2010-0113550 filed in the Korean Intellectual Property Office on Nov. 15, 2010, the entire contents of which are incorporated herein by reference.

### BACKGROUND OF THE INVENTION

(a) Field of the Invention

The present invention relates to a mobile Internet protocol television (IPTV) system and a method thereof. More particularly, the present invention relates to a mobile IPTV system capable of providing a supplementary service added to a broadcasting service via a mobile IPTV network, and a method thereof.

(b) Description of the Related Art

Of late, Internet protocol television (IPTV) services have evolved into IPTV services using the mobile Internet or mobile phones.

In the near future, IPTV will be allowed to re-transmit terrestrial broadcasting signals and consumers will then be able to be provided with real-time broadcasting services through IPTV. However, in order to attract existing cable TV or satellite TV subscribers to IPTV, there is a need to provide supplementary services sufficiently utilizing interactive characteristics of IPTV, as well as basic video services in the process of operating IPTV services. Supplementary services, having recently come to prominence, include bi-directional services, enhanced services, home gateway services, advertising revenue services, and the like.

However, a structure that provides such supplementary services using existing cable IPTV is not suitable to use in mobile IPTV systems. Therefore, a method of providing supplementary services by using a mobile IPTV system is being researched.

However, the current method of providing a supplementary service using mobile IPTV is highly disadvantageous in terms of security. That is, as data transmission for supplementary services passes through a wireless section, there is a risk that a third party might be able to easily acquire data. Therefore, a safe and convenient method of providing supplementary services over a mobile IPTV network is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a mobile Internet Protocol Television (IPTV) system and a method thereof having advantages of providing supplementary services by using mobile IPTV with enhanced security.

An exemplary embodiment of the present invention provides a mobile IPTV system. The mobile IPTV system providing a broadcasting service to a mobile terminal using an Internet Protocol (IP) includes: a service guide server for transmitting a service guide which includes programming information regarding a supplementary service added to the broadcasting service, to the mobile terminal; a media server for streaming contents for a supplementary service, selected from the service guide, to the mobile terminal; a mobile IPTV management server for receiving a request for the selected supplementary service from the mobile terminal, transmitting a control signal for the selected supplementary service to the supplementary service server, and performing user authentication for the selected supplementary service, and a supplementary service server for requesting the user authentication for the supplementary service from the mobile IPTV management server, and requesting the streaming of the contents from the media server.

Another embodiment of the present invention provides a method of providing mobile IPTV. The method of providing a mobile IPTV in a mobile IPTV system providing a broadcasting service to a mobile terminal using an Internet protocol (IP) includes: registering, by a mobile IPTV management server of the mobile IPTV system, server information upon receiving the server information from a supplementary service server of the mobile IPTV system; receiving, by the mobile IPTV management server, a request for a supplementary service added to the broadcasting service from the mobile terminal; and transmitting a control signal for the supplementary service to the supplementary service server by using the server information.

Yet another embodiment of the present invention provides a method of providing mobile IPTV. The method of providing mobile IPTV in a mobile IPTV system providing a broadcasting service to a mobile terminal by using an Internet protocol (IP) includes: receiving, by a service guide server of the mobile IPTV system, a service list, contents and summary information for a supplementary service from a supplementary service server of the mobile IPTV system; generating programming information regarding the supplementary service on the basis of information received from the supplementary service server and updating a service guide for mobile IPTV with the programming information; and transmitting the service guide to the mobile terminal.

Yet another embodiment of the present invention provides a method of providing mobile IPTV. The method of providing mobile IPTV in a mobile IPTV system providing a broadcasting service to a mobile terminal using an Internet protocol (IP) includes: receiving, by a supplementary service server of the mobile IPTV system, a control signal for a supplementary service from a mobile IPTV management server of the mobile IPTV system; requesting user authentication for the supplementary service from the mobile IPTV management server according to the control signal, and receiving a response thereto; requesting playback of contents for the supplementary service from a media server when the user authentication succeeds.

### BRIEF DESCRIPTION OF THE DRAWINGS

FIG. 1 is a schematic diagram of a mobile IPTV system according to an exemplary embodiment of the present invention.

FIG. 2 illustrates a transmitting/receiving path of an encrypted packet according to an exemplary embodiment of the present invention.

FIG. 3 illustrates a structure of an encrypted packet according to an exemplary embodiment of the present invention.

FIG. 4 is a flowchart illustrating a method of providing a mobile IPTV according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, user equipment (UE) may refer to a terminal, a mobile terminal (MT), a mobile station (MS), a subscriber station (SS), a portable subscriber station (PSS), an access terminal (AT) or the like, or may include the entirety or portion of the functions of the terminal, the MT, the MS, the SS, the PSS, the AT and the like.

Furthermore, a base station (BS) may refer to a node B (nodeB), an evolved node B (eNodeB), an access point (AP), a radio access station (RAS), a base transceiver station (BTS), a mobile multihop relay (MMR)-BS or the like, or may include the entirety or portion of the functions of the nodeB, the eNodeB, the AP, the RAS, BTS, the MMR-BS and the like.

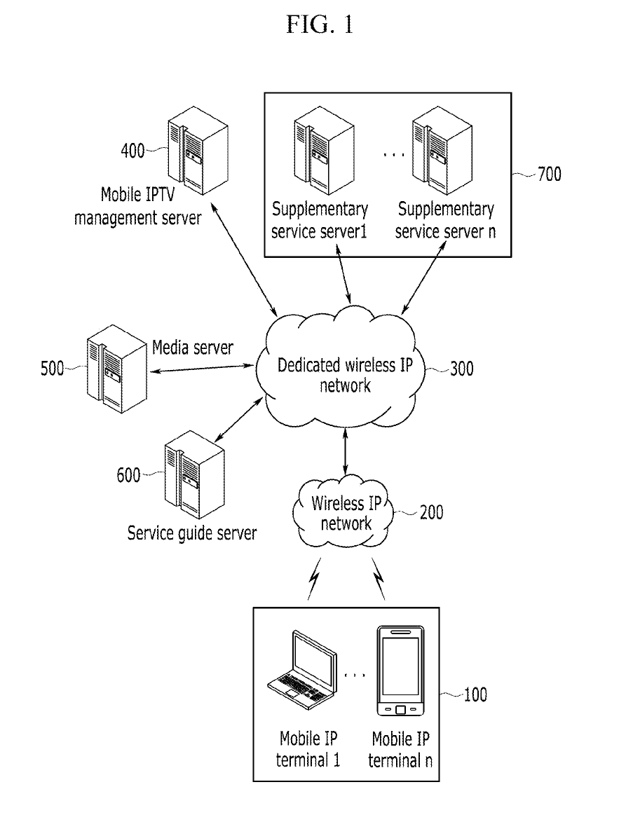

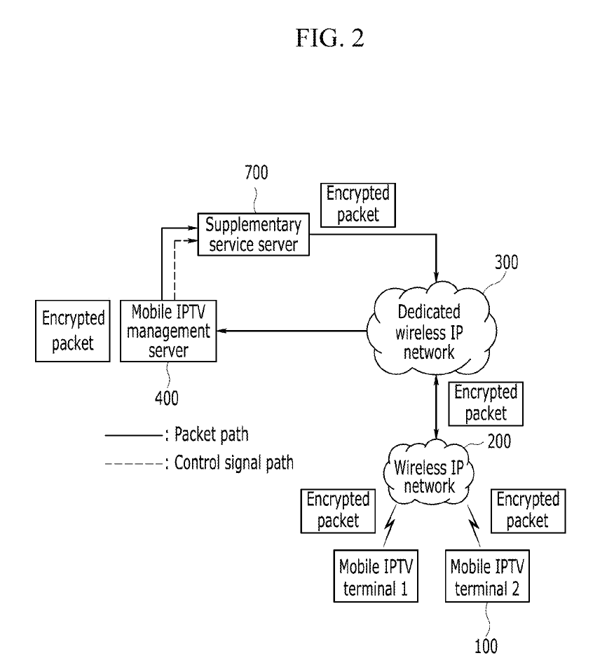

FIG. 1 is a schematic diagram of a mobile Internet protocol television (IPTV) system according to an exemplary embodiment of the present invention, and FIG. 2 illustrates a transmitting/receiving path of an encrypted packet according to an exemplary embodiment of the present invention.

Referring to FIG. 1, the mobile IPTV system includes at least one mobile terminal 100 (i.e., a terminal equipped with mobile IPTV functions, hereinafter, referred to as ‘a mobile IPTV terminal’), a wireless IP network 200, a dedicated wired IP network 300, a mobile IPTV management server 400, a media server 500, a service guide server 600, and at least one supplementary service server 700.

In this case, the mobile IPTV management server 400, the media server 500, the service guide server 600 and the at least one supplementary service server 700 are connected to the dedicated wired IP network 300 using the transmission control protocol/Internet protocol (TCP/IP). Also, the dedicated wired IP network 300 is connected to the wireless IP network 200 by a dedicated cable.

Furthermore, since the wireless IP network 200 has a narrow bandwidth, IEEE 802.16m and multicast techniques such as a mobile broadcasting service (MBS) or a multimedia broadcast and multicast service (MBMS) may be employed in order to overcome the limited bandwidth.

Here, the at least one mobile IPTV terminal 100 is a portable terminal equipped with a broadcasting reception function. Such a mobile IPTV terminal 100 is connected to the wireless IP network 200 and thus transmits/receives mobile IPTV data.

The at least one mobile IPTV terminal 100 may receive a linear TV channel, a video-on-demand (VOD) channel and bi-directional media contents.

The at least one mobile IPTV terminal 100 may be a media server 500 for another mobile IPTV terminal 100.

The mobile IPTV management server 400 receives a request for a supplementary service from the mobile IPTV terminal 100, transmits a control signal for the supplementary service to the supplementary service server 700, and performs user authentication for the supplementary service.

Furthermore, the mobile IPTV management server 400 performs user authentication upon receiving the control signal generated from the mobile IPTV terminal 100 even during content streaming, thereby providing a service desired by a user of the mobile IPTV terminal 100.

Here, a service request signal and a control signal, transmitted by the mobile IPTV terminal 100, are delivered to the mobile IPTV management server 400. The mobile IPTV management server 40 transmits a control instruction required for a mobile IPTV service requested by the mobile IPT terminal 100, to the media server 500. Furthermore, the mobile IPTV management server 40 updates a service guide server 600. Also, the mobile IPTV management server 400 transmits a control signal regarding a supplementary service among the mobile IPTV services to the supplementary service server 700.

The mobile IPTV management server 400 receives a service request from the mobile IPTV terminal 100, and controls the media server 500, the service guide server 600 and the at least one supplementary service server 700 in order to provide the requested mobile IPTV service/supplementary service.

The mobile IPTV management server 400 performs a cost charging function according to the use of the mobile IPTV service/supplementary service.

The mobile IPTV management server 400 determines Quality of Service (QoS) by using received channel data of the mobile IPTV terminal 100, and provides the same to the mobile IPTV terminal 100.

The media server 500 provides streaming of contents for the mobile IPTV service/supplementary service to the mobile IPTV terminal 100. In this case, the location of the media server 500 is designed according to the load of media streaming and the type of streaming.

The service guide server 600 transmits a service guide including programming information regarding the supplementary service, added to a broadcasting service, to the mobile IPTV terminal 100.

The service guide server 600 transmits an electronic program guide (EPG) or electronic contents guide (ECG) to the mobile IPTV terminal 100.

The mobile IPTV terminal 100 displays such an EPG or an ECG on a screen, thereby allowing a user to select a desired program or search for a desired program based on a reference such as a time, a title, a channel, a genre or the like and to conveniently use information regarding contents provided by a program provider, a location of an access server, an access right and the like.

In this case, the service guide server 600 provides an EGC or EPG including a service list and service summary information regarding the supplementary service registered by the at least one supplementary service server 700.

The at least one supplementary service server 700 exists for the same number of supplementary services. The at least one supplementary service server 700 may provide control and contents required for the supplementary service while directly communicating with the mobile IPTV terminal 100 according to a control signal received from the mobile IPTV management server 400. Here, to provide contents, the at least one supplementary service server 700 may transmit a control signal to the media server 500 and the service guide server 600 to thereby enable a specific operation for the supplementary service.

Furthermore, the supplementary service server 700 may transmit information required for cost charging to the IPTV management server 400.

Meanwhile, in order to request and control the supplementary service, a newly defined encrypted packet is transmitted/received between the mobile IPTV terminal 100, the mobile IPTV management server 400 and the supplementary service server 700.

As shown in FIG. 2, all of signals transmitted by the mobile IPTV terminal 100 are transmitted to the wireless IP network 200 in the form of an encrypted packet. These signals include a control signal and a signal requesting a supplementary service selected from the service guide by a user. Then, the wireless IP network 200 transmits an encrypted packet, as it is, to the dedicated wired IP network 300.

The mobile IPTV management server 400 decodes the encrypted packet received from the dedicated wired IP network 300, and extracts request information regarding a user, such as a user ID, a terminal identification number or the like. In this case, when it is determined that a supplementary service has been requested, a control signal for the supplementary service and the encrypted packet are transmitted to the supplementary service server 700. Here, the reason why the encrypted packet is transmitted to the supplementary service server 700 is to prevent private information leakage which may occur during a transmission process.

Thereafter, the supplementary service server 700 re-decodes the encrypted packet to process the same according to logic for providing the supplementary service.

Furthermore, when additional information for providing the supplementary service is required, the supplementary service server 700 adds an additional information request to the encrypted packet, and transmits the encrypted packet to the mobile IPTV terminal 100. At this time, the encrypted packet may be transmitted to the mobile IPTV terminal 100 with a ‘service type field’ set to ‘0000’.

Furthermore, when the ‘service type field’ of the encrypted packet is set to ‘0000’, the mobile IPTV terminal 100 may recognize that the supplementary service server 700 has successfully received the request for the supplementary service sent by the mobile IPTV terminal 100.

As above, the encrypted packet is secure from hacking during transmission.

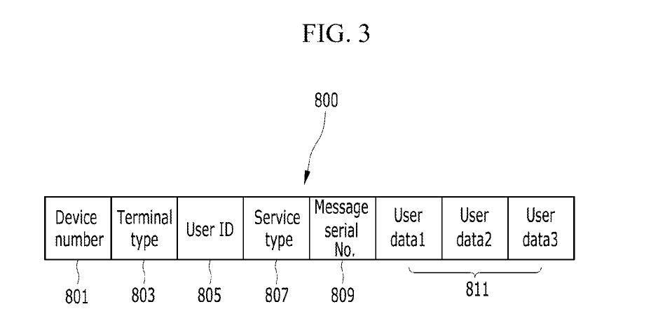

Here, the structure of the encryption packet is as shown in FIG. 3.

FIG. 3 illustrates a structure of an encrypted packet according to an exemplary embodiment of the present invention.

Referring to FIG. 3, an encryption packet 800 has eight fields, and each field has a function of its own. The entire length of the encrypted packet 800 is 488 bytes. This therefore facilitates transmission and encryption through a narrow radio channel. A TCP/IP packet header is added to the encrypted packet 800.

Here, the encrypted packet 800 includes a device number field 801, a terminal type field 803, a user ID field 805, a service type field 807, a message serial number field 809, and a user data field 811.

The device number field 801 specifies a device number, an identification number of the mobile IPTV terminal 100. The device number is used when the supplementary service server 700 authenticates the mobile IPTV terminal 100.

The terminal type field 803 specifies information regarding the predefined type of the mobile IPTV terminal 100, that is, a terminal type. The terminal type includes a resolution, a communication capability, the capacity of a central processor unit (CPU), and a terminal function. Also, the terminal type field 803 is used to determine available contents and a kind of service to be provided by the supplementary service server 700.

The user ID field 805 specifies identification information for identifying a user, that is, a user ID, and the user ID is used for a user profile and an authentication process.

The service type field 807 specifies a service type desired by a user. A value recorded in the service type field 807 is defined prior to a service. The supplementary service server 700 checks the service type field 807 to confirm a service desired by a user. Furthermore, when the service type field 807 is set to ‘0000’, this indicates that a packet is transmitted from a server to a terminal.

The message serial number field 809 specifies a serial number of a user message. The message serial number is sequentially generated in the mobile IPTV terminal 100. The message serial number field 809 facilitates message checking and error detection.

The user data field 811 may consist of three fields, and data required for a supplementary service is specified therein. The user data field 811 is used when information for a supplementary service is transmitted from the mobile IPTV terminal 100 to the supplementary service server 700.

In the encrypted packet 800, the device number field 801, the terminal type field 803, the user ID field 805, the service type field 807, the message serial number field 809, the user data field 811 are allocated with 15 bytes, 4 bytes, 15 bytes, 7 bytes, 7 bytes, and 90 bytes, respectively.

Hereinafter, a series of processes of providing a mobile IPTV service in the above mobile IPTV system will be described.

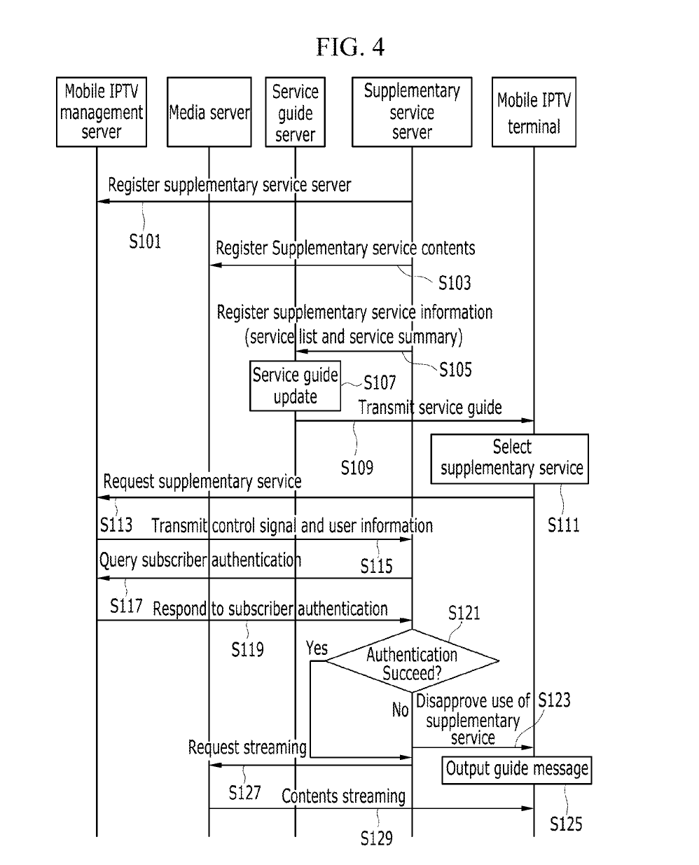

FIG. 4 is a flowchart illustrating a method of providing a mobile IPTV according to an exemplary embodiment of the present invention.

Referring to FIG. 4, the supplementary service server 700 registers service information with the mobile IPTV management server 400 in operation S101. Also, the supplementary service server 700 registers contents for a supplementary service with the media server 500 in operation S103.

The supplementary service server 700 registers supplementary service information, that is, a supplementary service list and service summary information, with the service guide server 600 in operation S105. Then, in operation S107, the service guide server 600 updates a service guide with programming information regarding the supplementary service on the basis of the supplementary service list and service summary information received in operation S105.

The service guide server 600 transmits the service guide, updated in operation S107, to the mobile IPTV terminal 100 in operation S109.

In operation S111, the mobile IPTV terminal 100 selects a supplementary service desired by a user among supplementary services displayed on the service guide received in operation S109. That is, the supplementary service may be selected by selecting an EPG and/or an ECG, or the supplementary service may be requested as a user presses a specific button provided on the mobile IPTV terminal 100.

In operation S113, the mobile IPTV terminal 100 transmits an encrypted packet for requesting the supplementary service, selected in operation S111, to the mobile IPTV management server 400.

In operation S115, the mobile IPTV management server 400 transmits the encrypted packet received in operation S113, and a control signal according to information, extracted by decoding the encrypted packet received in operation S113, to the supplementary service server 700. At this time, the transmission to the supplementary service server 700 is made by using the server information, registered by the supplementary service server 700 in operation S101.

In operation S117, the supplementary service server 700 decodes the encrypted packet received in operation S115 and makes a query to the mobile IPTV management server 400 to determine whether or not the request for the supplementary service, transmitted by the mobile IPTV terminal 100, is appropriate.

The mobile IPTV management server 400 performs user authentication with respect to the mobile IPTV terminal 100, having requested the supplementary service, on the basis of the information extracted by decoding the encrypted packet received in operation S113, and then returns a response to the supplementary service server 700 in operation S119.

In operation S121, the supplementary service server 700 determines whether the user authentication succeeds or fails based on the response received in operation S119, and if the user authentication fails, the supplementary service server 700 transmits a disapproval of the use of the supplementary service to the mobile IPTV terminal 100 in operation S123. Then, the mobile IPTV terminal 100 outputs a message, showing that the supplementary service is unavailable, to a screen in operation S125.

However, if it is determined that the user authentication succeeds in operation S121, the supplementary service server 700 requests the streaming of contents for the supplementary service from the media server 500 in operation S127. Then, the media server 500 provides the streaming of corresponding contents to the mobile IPTV terminal 100 in operation S129. At this time, when a request is received from the mobile IPTV terminal 100, the media server 500 makes a response to the mobile IPTV terminal 100.

In that case, when the packet streams of the corresponding contents for the supplementary service are received from the media server 500 in operation S129, the mobile IPTV terminal 100 buffers the received packet streams, converts them into a standard TV signal and outputs the same.

Although not shown in the drawings, there may be an exemplary embodiment in which the mobile IPTV terminal 100 has a built-in global positioning system (GPS) sensor or acceleration sensor mounted therein, transmits information measured using the built-in sensor to the supplementary service server 700, and is provided with a supplementary service according to the measured information. Such a supplementary service may include emergency notification services usable in vehicles, and reservation services for movies, hospitals or the like.

According to an exemplary embodiment of the present invention, data for a supplementary service of mobile IPTV is transmitted/received by using a transmission control protocol/Internet protocol (TCP/IP)-based encrypted packet structure, thereby reducing a risk of private information leakage and easily providing a supplementary service.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A mobile Internet protocol television (IPTV) system providing a broadcasting service to a mobile terminal using an Internet Protocol (IP), the mobile IPTV system comprising:
a service guide server for transmitting a service guide which includes programming information regarding a supplementary service added to the broadcasting service, to the mobile terminal;
a media server for streaming contents for a supplementary service, selected from the service guide, to the mobile terminal;
a mobile IPTV management server for receiving a request for the selected supplementary service from the mobile terminal, transmitting a control signal for the selected supplementary service to the supplementary service server, and performing user authentication for the selected supplementary service, and
a supplementary service server for requesting the user authentication for the supplementary service from the mobile IPTV management server, and requesting the streaming of the contents from the media server.

2. The mobile IPTV system of claim 1, wherein the supplementary service server registers a program or contents for the supplementary service with the service guide server and the media server, and
the service guide server updates an electronic program guide (EPG) or an electronic contents guide (ECG) to include programming information regarding the program or contents.

3. The mobile IPTV system of claim 2, wherein the supplementary service server registers server information with the mobile IPTV management server, wherein the service information is used when the mobile IPTV management server transmits the control signal to the supplementary service server.

4. The mobile IPTV system of claim 1, wherein the service guide server, the media server, the mobile IPTV management server and the supplementary service server are connected to each other via a dedicated wireless IP network.

5. The mobile IPTV system of claim 4, wherein the supplementary service server is connected to the service guide server, the media server and the mobile IPTV management server via the dedicated wireless IP network by using a transmission control protocol/Internet protocol (TCP/IP).

6. The mobile IPTV system of claim 1, wherein the mobile terminal transmits an encrypted packet including the request for the supplementary service to the mobile IPTV management server, and receives an encrypted packet including information for the supplementary service from the supplementary service server, and
the mobile IPTV management server transmits the received encrypted packet and a control signal according to information extracted by decoding the encrypted packet received from the mobile terminal, to the supplementary service server.

7. The mobile IPTV system of claim 6, wherein the encrypted packet includes a plurality of newly defined fields specifying the information for the supplementary service, and a transmission control protocol/Internet protocol header is added to the encrypted packet.

8. The mobile IPTV system of claim 7, wherein the encrypted packet comprises:
a first field specifying an identification number of the mobile terminal;
a second field specifying type information regarding the mobile IPTV terminal;
a third field specifying identification information of a user;
a fourth field specifying information for message error and checking; and
at least one fifth field specifying data for a supplementary service.

9. A method of providing a mobile Internet protocol television (IPTV) in a mobile IPTV system providing a broadcasting service to a mobile terminal using an Internet protocol (IP), the method comprising:
registering, by a mobile IPTV management server of the mobile IPTV system, server information upon receiving the server information from a supplementary service server of the mobile IPTV system;
receiving, by the mobile IPTV management server, a request for a supplementary service added to the broadcasting service from the mobile terminal; and
transmitting a control signal for the supplementary service to the supplementary service server by using the server information.

10. The method of claim 9, wherein the receiving comprises:
receiving, by the mobile IPTV management server, an encrypted packet, requesting the supplementary service, from the mobile terminal; and
extracting information for the supplementary service by decoding the encrypted packet, and
the transmitting includes transmitting the control signal for the supplementary signal according to the extracted information, and the encrypted packet to the supplementary service server.

11. A method of providing mobile Internet protocol television (IPTV) in a mobile IPTV system providing a broadcasting service to a mobile terminal by using an Internet protocol (IP), the method comprising:
receiving, by a service guide server of the mobile IPTV system, a service list, contents and summary information for a supplementary service from a supplementary service server of the mobile IPTV system;
generating programming information regarding the supplementary service on the basis of information received from the supplementary service server and updating a service guide for mobile IPTV with the programming information; and
transmitting the service guide to the mobile terminal.

12. A method of providing mobile Internet protocol television (IPTV) in a mobile IPTV system providing a broadcasting service to a mobile terminal using an Internet protocol (IP), the method comprising:
receiving, by a supplementary service server of the mobile IPTV system, a control signal for a supplementary service from a mobile IPTV management server of the mobile IPTV system;
requesting user authentication for the supplementary service from the mobile IPTV management server according to the control signal, and receiving a response thereto;
requesting playback of contents for the supplementary service from a media server when the user authentication succeeds.

13. The method of claim 12, wherein, in the receiving of the control signal, the control signal and an encrypted packet transmitted by the mobile terminal to request the supplementary service are received, and
in the requesting, the playback of the contents for the supplementary service is requested from the media server on the basis of information extracted by decoding the encrypted packet.

14. The method of claim 13, further comprising, after the requesting, specifying, by the supplementary service server, a predefined specific value in a predetermined specific field of the encrypted packet, and transmitting the encrypted packet to the mobile terminal.
